(19) United States
(12) Patent Application Publication
(10) Pub. No.: US 2020/0099763 A1
(43) Pub. Date: Mar. 26, 2020

(54) INDICATION OF UPDATES TO A CACHED VERSION OF A DOCUMENT

(71) Applicant: Microsoft Technology Licensing, LLC, Redmond, WA (US)

(72) Inventors: Arturo Goicochea, Seattle, WA (US); Manish Kumar Shukla, Lexington, MA (US)

(21) Appl. No.: 16/197,859

(22) Filed: Nov. 21, 2018

Related U.S. Application Data
(60) Provisional application No. 62/734,551, filed on Sep. 21, 2018.

(51) Int. Cl. H04L 29/08; G06F 17/24; H04N 1/32; G06T 1/00

(52) U.S. Cl. CPC H04L 67/2819; H04L 67/1095; G06T 1/0021; G06F 17/24; H04N 1/32144; H04L 67/2842

(57) ABSTRACT

Systems, methods, and software are disclosed herein for indicating that a change made to content in a collaborative document is updating on a cached version displayed to a user. A cached version of a collaborative document is displayed in a user interface to an application. A source of the collaborative document external to the cached version of the collaborative document is then queried for changes that have occurred to content within the collaborative document since the cached version of the collaborative document was generated. If a change has occurred to the content within the collaborative document, an indication is displayed in the user interface that the cached version of the collaborative document is being updated based on the change.

### RELATED APPLICATIONS

This claims priority to and benefit from U.S. Provisional Patent Application Ser. No. 62/734,551, filed on Sep. 21, 2018, titled “Indication of Updating Changes to a Cached Version of a Document,” which is expressly incorporated by reference herein.

### TECHNICAL FIELD

Aspects of the disclosure are related to computing hardware and software technology, and in particular to indicate that the cached version of the collaborative document is being updated based on a change to the source of the collaborative document.

### TECHNICAL BACKGROUND

Many software applications provide users with the capability to co-author and edit content in a collaborative document. These software applications include related data compiled into the document which may be added to or changed by any of the users accessing the document within the same or different software application, such as in a cloud computing environment. These software applications provide advantages over traditional document editing, including traditional computer-based document editing (i.e., editing and exchanging different document versions amongst co-authoring users), in that it allows co-authors to simultaneously view added content and edits within the document that are being made by other co-authors, while eliminating the need for users to send individual edit instances of the document to one another, which may reflect outdated information when two or more users are editing a document at the same time.

Once a user receives a notification about a change or that a comment has been made by another collaborator in the cloud-hosted document, the user may want to open the document and view the content referenced by the notification. However, a user's local cached copy of the document may not have been updated with the referenced change. Therefore, the user likely would need to wait for an updated version of the document to be generated and would not be able to view the document until all of the changes have been merged into the document. Unfortunately, this can lead to a slow loading process when displaying the document to the user and prevent the user from viewing content that may already be included in the cached version of the document while the user waits for the changes to be merged. This limits an ability of the application to enhance a user experience when opening a collaborative document.

### OVERVIEW

An enhanced system, method, and software application is disclosed herein that improves indicating that a change made to content in a collaborative document is updating on a cached version displayed to a user. A cached version of a collaborative document is displayed in a user interface to an application. A source of the collaborative document external to the cached version of the collaborative document is then queried for changes that have occurred to content within the collaborative document since the cached version of the collaborative document was generated. If a change has occurred to the content within the collaborative document, an indication is displayed in the user interface that the cached version of the collaborative document is being updated based on the change.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational architecture for implementing an enhanced application to indicate that a change made to content in a collaborative document is updating on a cached version displayed to a user.

FIG. 2 illustrates an indication process employed in implementations of an enhanced application to display an indication in a document of changes made to content at the source external to a cached version of a collaborative document.

FIG. 3 illustrates an operational scenario in an implementation of an enhanced application to illustrate exemplary user interfaces in an implementation of an enhanced application to indicate that a change made to content in a collaborative document is merging into a cached version displayed to a user when a file is open.

FIG. 4 illustrates exemplary user interfaces in an implementation of an enhanced application to indicate that a change made to content in a collaborative document is updating on a cached version displayed to a user.

FIG. 5 illustrates a flow diagram in an implementation of an enhanced application to indicate that a change made to content in a collaborative document is updating on a cached version displayed to a user.

FIG. 6 illustrates another flow diagram in an implementation of an enhanced application to indicate that a change made to content in a collaborative document is updating on a cached version displayed to a user.

FIG. 7 illustrates a computing system suitable for implementing the technology disclosed herein, including any of the architectures, processes, operational scenarios, and operational sequences illustrated in the Figures and discussed below in the Technical Description.

### TECHNICAL DESCRIPTION

Examples of the present disclosure describe an application for indicating that a change made to content in a collaborative document is updating on a cached version displayed to a user. A cached version of a collaborative document is displayed in a user interface to an application. A source of the collaborative document external to the cached version of the collaborative document is then queried for changes that have occurred to content within the collaborative document since the cached version of the collaborative document was generated. If a change has occurred to the content within the collaborative document, an indication is displayed in the user interface that the cached version of the collaborative document is being updated based on the change.

A technical effect that may be appreciated from the present discussion is the increased efficiency in identifying changes made to content within a collaborative document while displaying the latest cached version in the user interface. The application described herein also improves the efficiency in notifying users that the content is not up-to-date but allows the user to navigate to the location in the cached version of the document in which the change was made. Advantageously, the user does not need to wait for the cached version of the collaborative document to merge the changes before viewing, which may take a considerable amount of time when a high volume of changes has been made or when a connection to a server storing the source collaborative document is not running efficiently.

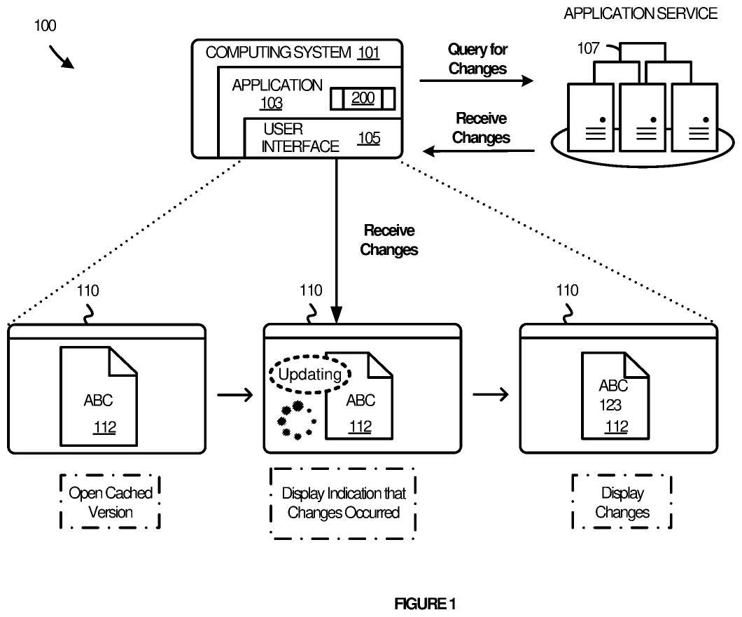

Referring to the drawings, FIG. 1 illustrates an exemplary operational architecture 100 related to processing operations for management of an exemplary enhanced system with which aspects of the present disclosure may be practiced. Operational environment 100 includes computing system 101 comprising application 103. Application 103 employs an indication process 200 in the context of indicating that a change made to content in a collaborative document is updating on a cached version displayed to a user in user interface 105. User interface 105 displays the cached version of collaborative document 112 as well as an indication that changes are being merged into the cached version of collaborative document 112.

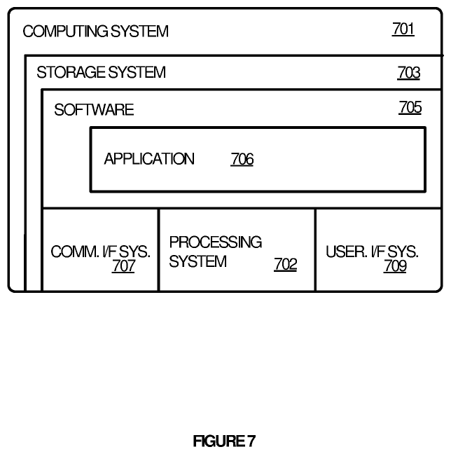

Computing system 101 is representative of any device capable of running an application natively or in the context of a web browser, streaming an application, or executing an application in any other manner. Examples of computing system 101 include, but are not limited to, personal computers, mobile phones, tablet computers, desktop computers, laptop computers, wearable computing devices, or any other form factor, including any combination of computers or variations thereof. Computing system 101 may include various hardware and software elements in a supporting architecture suitable for performing indication process 200. One such representative architecture is illustrated in FIG. 7 with respect to computing system 701.

Application 103 includes a software application or application component capable of indicating that a change made to content in a collaborative document is updating on a cached version displayed to a user in accordance with the processes described herein. Examples of the software application include, but are not limited to, note taking applications, document drafting applications, spreadsheet applications, presentation applications, messaging applications (e.g., email and text messaging), and any other type of combination or variation thereof. The software application may be implemented as a natively installed and executed application, a web application hosted in the context of a browser, a streamed or streaming application, a mobile application, or any variation or combination thereof.

User interface 105 includes representative view 110 that may be produced by application 103. Representative view 110 may present a cached version of collaborative document 112 comprising content (i.e., “123”). The cached version is also accompanied by an indication that changes are being processed into the cached version of collaborative document 112. An end user may interface with application 103 using user interface 105. The user may interface with application 103 over user interface 105 using an input instrument such as a stylus, mouse device, keyboard, touch gesture, as well as any other suitable input device. The user may initiate a command to view or navigate to a change made to the content by entering user input.

Operational environment 100 also includes application service 107. Application service 107 is representative of any device capable of running an application natively or in the context of a web browser, streaming an application, or executing an application in any other manner. Examples of application service 107 include, but are not limited to, personal computers, mobile phones, tablet computers, desktop computers, laptop computers, wearable computing devices, or any other form factor, including any combination of computers or variations thereof.

Application service 107 may include a software application or application component capable of indicating a change to content in a document in accordance with the processes described herein. Examples of the software application include, but are not limited to, presentation applications, diagramming applications, computer-aided design applications, productivity applications (e.g. word processors or spreadsheet applications), and any other type of combination or variation thereof. The software application may be implemented as a natively installed and executed application, a web application hosted in the context of a browser, a streamed or streaming application, a mobile application, or any variation or combination thereof.

Document 112 may be a presentation, canvas or diagram, productivity document (e.g. text document or spreadsheet), and any other type of combination or variation thereof. Document 112 may be generated in application service 101 by a user or another application service by another user, such as application service 107. For instance, a user may create document 112 by uploading a template or generating a document from scratch including, but not limited to, electronic word documents, spreadsheets, photos, text messages, websites, media content, articles, handwritten notes written in digital ink, etc. Some exemplary applications are further configured to enable users to pull previously generated documents locally (e.g. from a storage of a specific computing device) and share documents with multiple users using application service 107 and application service 101 via a network connection (e.g. retrieve from a distributed storage, website, etc.).

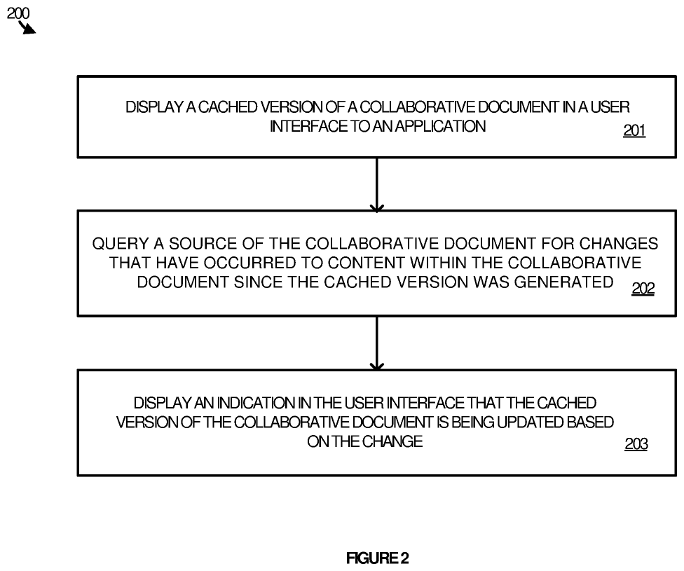

More particularly, FIG. 2 illustrates indication process 200 which, as mentioned, may be employed by application 103 to indicate that a change made to content in a collaborative document is updating on a cached version displayed to a user as described herein. Some or all of the steps of indication process 200 may be implemented in program instructions in the context of a component or components to the application used to carry out the indication feature. The program instructions direct computing system 101 to operate as follows, referring parenthetically to the steps in FIG. 2 in the context of FIG. 1.

In operation, application 103 displays a cached version of collaborative document 112 in user interface 105 to application 103 (step 201). Application 103 may open the cached version of document 112 in response to a user receiving a notification of a change made to document 112 and user input indicating that the user would like to view the change. Document 112 may be opened in a state where the latest changes that the user expects to see are visible and the user can easily and quickly accomplish subsequent collaborative tasks. For example, when the user invokes a notification (i.e., via an email or a push notification) about a comment or mention in document 112, the latest cached file for document 112 is opened. In some example scenarios, the user is navigated to the location in document 112 of the comment that the notification referred to.

In another example, a user may receive an email notification with a summary of changes made to document 112 and comments made by others. When the user clicks the email to open the file, the file will open with the latest content in the file. The user may open the file from a Most Recently Used (MRU) file or from any other place in which the user or other users have made changes to document 112. While the user may or may not know about these changes, application 103 may determine the user's context of document 112. In this example, application 103 may need to ensure that the latest version of the file is shown with a summary and/or a catch-up highlight to help the user catch up on changes that have been made to document 112 since the latest version.

In one example, the user navigates to a comment or mention in the document by clicking a push or email notification about a comment or mention. The latest version of the file opens to the place where the comment is anchored to and the comment is shown along with catch up highlights. Various scenarios may be used for navigation to a comment or a mention. For example, a text document application may have a durable comment identifier which allows the application to navigate to the comment. A presentation application may use a durable identifier for slides only and will therefore navigate to the slide. In other example, a spreadsheet application may use two identifiers: a sheet and a comment identifier, each of which may be durable and will allow the application to navigate to the right comment.

In another example, collaborative document 112 is opened from a digest email notification. In this example, the user receives an email with a summary of changes, comments, and mentions that have been made to the document by other users or by the user on another device. The user may then click or tap the document link in the email, and the cached version of the file opens. Current applications do not allow a user to navigate from a comment notification when the comment notification is a stale copy of the file in the cache. A comment notification typically refers to a state or version of the file that is newer than the one in cache, and this may cause navigation to the comment to fail. Unfortunately, the summary or highlight up may not be shown over the stale cache file. If a cached version of the file opens, depending on timing of summary with respect to when the latest version of file was downloaded, the summary will be referring to authors and changes that do not exist in the version of file that opens.

Current applications also generally include additional and often too many biz-bars on file open which are generally not effective. Furthermore, showing too many biz-bars more often increases the likelihood of users ignoring them. Therefore, when the user asks to open the file to specific content (e.g. when clicking comment notification), the application will take the user to that content, without any additional user input to resubmit their request.

It should be noted that the term “collab-ready” may refer to enabling and encouraging collaboration by ensuring that files open in a way that allows users to read, comment on, and edit the latest content of document 112. Advantageously, this provides users with friction-free collaboration that they can collaborate on their own terms, at the right time, and in the right place for them. For example, this could be when working on a desktop computer, while quickly moving a project along from their phone, while accessing work files anywhere from the browser, etc. To meet these needs files may need to be opened collab-ready on all platforms. In one example, the latest content that the user expects to see is displayed in user interface 105. Advantageously, the user may see the cached version of the document while managing their expectations that document 112 is in the process of updating without requiring the user to perform additional requests.

In a next operation, application 103 then queries a source of collaborative document 112 external to the cached version of the collaborative document 112 for changes that have occurred to content within collaborative document 112 since the cached version of collaborative document 112 was generated (step 202). For example, the application may open collaborative document 112 with an indicator that changes made by others are updating and will be highlighted once they have been merged. In yet another example, the user may be returning to the file after other users have made changes. In this example, the latest version of the file opens and show an indication that a summary flyout will be shown that provides the user with a summary of what happened in the file and showcases the authors who have made changes in this file since the user had last opened the file. In another example scenario, the user may make changes to the file on another device. Once the user opens the file in a desktop or mobile environment after making changes on another endpoint or device, the latest version of the file may open quickly with an indicator that the changes made on the other device are in the process of being merged.

The application also provides feedback to the user when the content cannot be found. If cached content is loaded, users may be made aware of changes being downloaded from the server if such changes exist. Application 103 may open the cached version of the file first, then download latest changes from the server and merge the changes if the user had opened the file previously, or it is in the cache via a sync client. Advantageously, this enables users to get back to the file quickly. There are variations in how long it takes to refresh the file to the latest version depending on whether the file is sync-backed (and thus most likely up-to-date) or is just a non-synced file. It should also be noted that a Zero-Roundtrip (ZRT) file open may be used in some exemplary scenarios.

Unfortunately, refreshing and merging may take a long time if the file has been changed substantially since the version that is in the cache. Furthermore, the user's work (reading or editing) that they had begun in the opened cached copy is interrupted by the subsequent refresh and merge. Additionally, when the cache file is not fresh, the application may need to interact with other features. For example, features that need to be updated or accounted for. Whenever the file opens after navigating or deep-linking from notification, the While you were away (WYWA) summary and the Where you left off (WYLO) summary may be suppressed. Additional features which may be suppressed include bars and pop-ups, such as Rate us.

On the other hand, catch-up highlights may usually be shown on file open. If a sign-in is required to open the file, the user may be prompted first. After a successful sign-in, the rest of the flow may be the same as when user was signed in. It should be noted that if recovery documents exist (i.e. on a desktop application), this should not impact the experience. In certain cases, the application may be in a state where the navigation or deep-linking will fail, such as for document recovery or when the license for the application has expired. Document types and states may include password protected files or Information Rights Management (IRM)'d files, such as where the ZRT is de-activated, there is no auto-save, or the changes cannot be merged (e.g., file is already open, or file has pending changes). Additionally, if that file is currently in a compare/restore mode, navigation may fail.

If a change has occurred to the content within the collaborative document, application 103 displays an indication in the user interface that the cached version of the collaborative document is being updated based on the change (step 203). After opening to the cached copy, the application may open to the closest place in file to minimize scrolling after the cached copy has been refresh. A refresh may be initiated from the server and the application may show a loading progress indicator and provide a message saying, “fetching latest comments from server”. This callout may be in the same place where the summary is shown. This call-out would not block the user from interacting with the document or editing it. However, the user may need to manually dismiss this progress indicator. The callout will transition to success states or error states depending on whether the navigation is completed in deep-linking or navigation scenarios. In flows where the summary needs to be shown, this progress callout will transition to the summary. To reduce the number of instances in which this progress is shown, the application may delay the loading progress callout, such as by one second.

To ensure the user interface does not flicker leaving users wondering what happened, this progress indicator may be shown on the user interface for at a specified amount of time. The user can interact with the document or start editing it without dismissing this progress indicator. If the user dismisses or starts editing the file, the application may not be able to navigate. Thus, it is important that the application draw the user's attention to this callout so they can consciously choose to wait for the content to load. To achieve this, an animating spinner in the callout may be used to draw the user's attention.

The callout design is noted because no per-file modal progress indicator may exist and the callout-based progress may seamlessly transition to the summary in non-deep-linking or navigation when the file opens. Advantageously, this prevents users from feeling lost by not seeing the changes they expect and stop them from interacting with the document. This may be a modal dialog that can be put over the file and the user can dismiss to cancel the navigation intent. The progress indicator string will be contextual based on whether the user is trying to get to a mention or comment or has just opened the document from an edit notification or a general open.

When the navigation is completed, the application may first show a successful loading message. For example, a progress indicator transitions if the user did not dismiss it and may come back if the user had not started editing the document. Once the progress indicator transitions to success, the document is scrolled to the correct anchor point for the comment. The comment may be shown in a floatie experience if available. If not, a comment pane may be opened so the comment is visible. When the user has started editing the document and the content becomes available, if the user has started editing, the application may not automatically navigate to the comment once it is loaded. The application may also check to see if the comment that the user wanted to see exists in the document. On the other hand, the navigation may fail if the application is offline, if an error occurred while refreshing or merging, or if the content could not be found, such as when a presentation slide no longer exists.

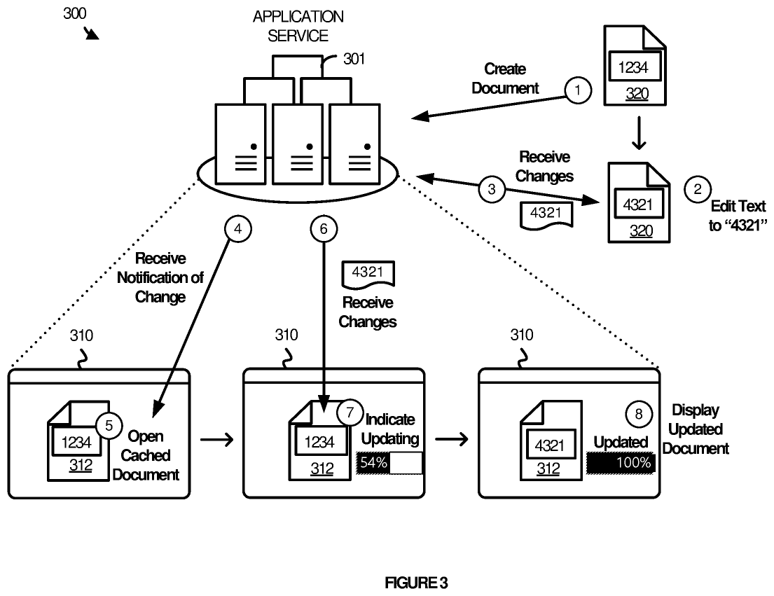

FIG. 3 illustrates an exemplary operational architecture for displaying an indication in a document of a change made at the source that may be used in one or more scenarios of the present technology. FIG. 3 illustrates an operational scenario 300 that relates to what occurs when content is changed at a source of the collaborative document and a user desires to view a cached version of the collaborative document while the changes are being merged into the cached version of the document. Operational scenario includes application service 301, user interface 310, cache version of document 312, and source version of document 320.

In operation, application service 301 displays a cached version of collaborative document 312 in user interface 310. In a presentation application, the application may open to the right slide if it already exists in the cached copy. In a spreadsheet application, the application may open to the right sheet if it already exists in the cached copy. In a next operation, application service 301 then queries a source version of collaborative document 320 external to the cached version of the collaborative document 312 for changes that have occurred to content within the source version of the document 320 since the cached version of collaborative document 312 was generated.

If a change has occurred to the content within the collaborative document, application service 301 displays an indication in the user interface that the cached version of the collaborative document is being updated based on the change. The progress may be shown to the user until the first refresh/merge has been completed from the server, or when the refresh/merge fails. If the refresh can't be initiated due to the application being offline or having limited connectivity, the user may be shown a message saying, “couldn't fetch latest changes from server.”

Once the refresh/merge has been completed and the updated content (i.e., 4321) is in the refreshed file, application service 301 navigates to the location of the updated content in document 312 and makes the updated content visible. If the updated content cannot be found, the user is shown a message saying, “updated content has been moved or deleted”. The user may then dismiss the progress or start editing the document. This will cancel the navigation.

The application may also have an identifier/watermark for the file that can be used to check if the version of the file in cache is fresh with respect to the version that the notification refers to. This watermark will be plumbed through via both push navigation and email deep-linking paths and will be made available in a document cache, such as Office Document Cache®. Advantageously, a freshness check allows application service 301 to avoid showing progress indicator if the content is fresh and the navigation fails because the updated content or mention has been removed. If the freshness check is not performed, the application may always show progress for the updated file, even if the file in cache is up-to-date.

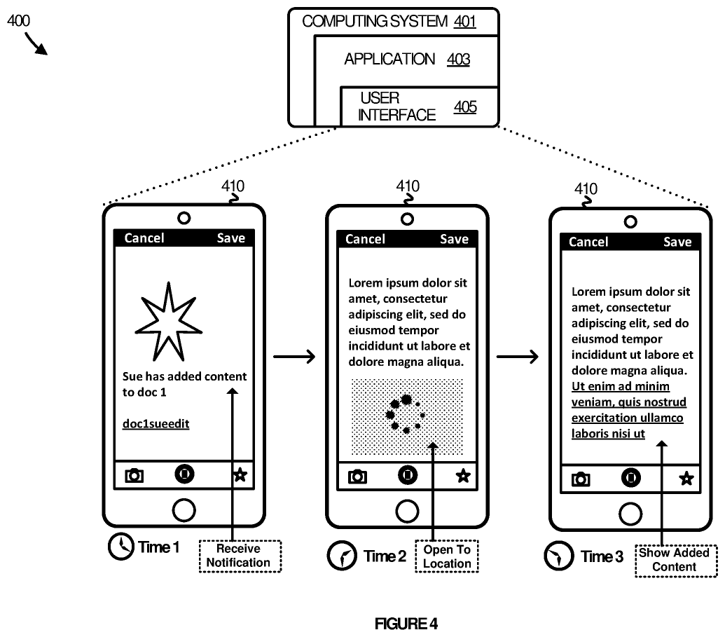

FIG. 4 illustrates a user interface in an exemplary operational scenario for displaying an indication in a document of a change made at the source that may be used in one or more scenarios of the present technology. FIG. 4 illustrates example scenarios of navigating from push or deep-linking from email when a comment or mention notification is clicked by a user. In this example, at time 1, a notification message may be sent to a user and displayed in user interface 405. In a next operation, at time 2, the cached version of the document is opened to the location in which the edit was made. For example, the progress indicating shows over the located of the added content.

When the navigation is completed, the progress indicator transitions to indicate success, or comes back if user has not started editing. In some example scenarios, the progress indicator may be automatically dismissed after being shown for a few seconds. Once the progress indicator transitions to success, the document is scrolled down to the anchor point for the added comment. In some scenarios, once the user begins to edit the document, the content may become available. In another scenario, if auto-save is off and there are pending changes in the file, a consumption view or read-mode may surface in user interface 405.

Application 403 may also enter an edit-mode from a consumption-mode which may not dismiss the collab-ready progress indicator. In another example, the file may be opened from an edit. In this scenario, if the cached file is opened, and if it is not fresh with respect to the notification, a progress indicator may be shown until the latest changes have been downloaded and refreshed. At time 3, the added content is shown user interface 405. For example, once the latest content is refreshed, the progress will be dismissed and catch up highlights will be shown.

In yet another example scenario, the file may be opened after a sync collaboration or based on edits from a different device. In this scenario, application 403 may detect early that there are changes on the server and that the cached copy is not fresh. Application 403 may then use a progress indicator until a refresh or merge is made from the server. The progress indicator will then transition to the summary where the sync collaboration has happened.

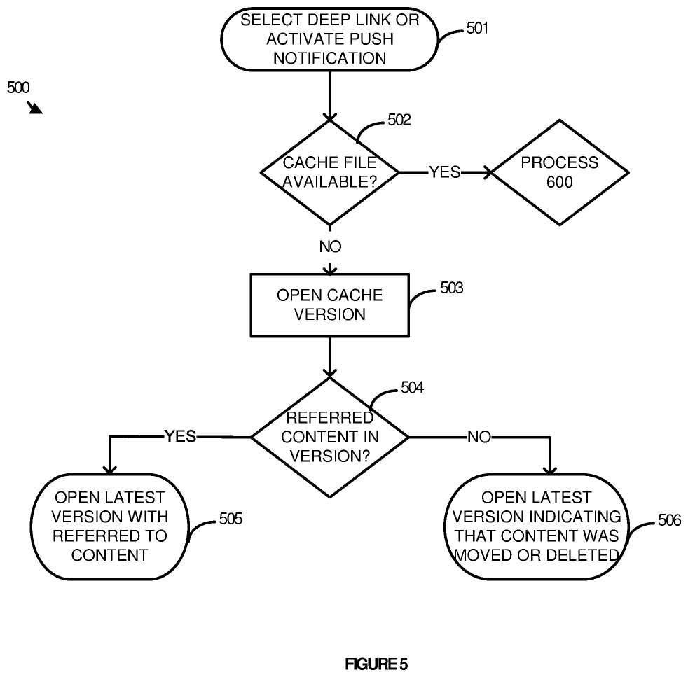

FIG. 5 illustrates a flow diagram in an implementation of an enhanced application to indicate that a change made to content in a collaborative document is updating on a cached version displayed to a user. In a first step, the user activates a deep-link or navigates to the cache file via a notification (step 501). The application then determines whether the cache file is available (step 502). If the file is not in cache, the file will be opened to its latest version downloaded from the server (step 503). The application then determines whether the referred content is included in the latest version downloaded from the server (step 504). If the referred content is available, the first view will show the anchor location of the comment and/or mention (step 505). If the comment cannot be found, the user may be shown a message saying, “comment has been moved or deleted” (step 506). If the user is offline, the file open may fail, and the navigation may not be completed. Therefore, in this example scenario, the existing file open failure experience is sufficient.

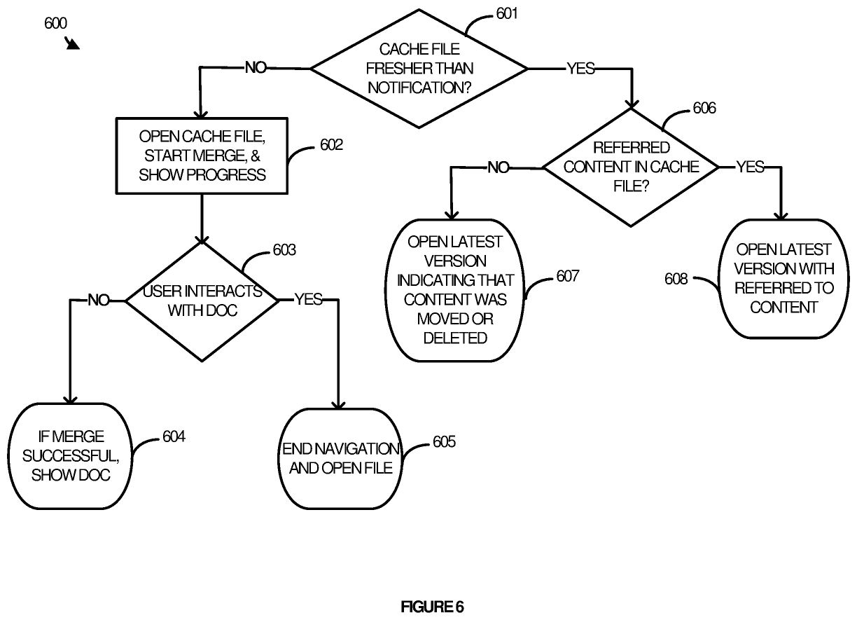

FIG. 6 illustrates a flow diagram in an implementation of an enhanced application to indicate that a change made to content in a collaborative document is updating on a cached version displayed to a user. Process 600 stems from step 502 of process 500 included in FIG. 5. If the file is in cache, the application may check freshness and navigate to the comment if the file is fresh (step 601). The application may then check whether the copy of the file in the cache is fresh enough with respect to the version that the notification refers to. If the file in cache is not fresh, the application may navigate into the cached copy, begin merging the changes, and show a progress indicator (step 602).

At this point the user may interact with the file (step 603). If the merge is successful and the user does not interact with the file, then the document is opened to the location of the comment in the file (step 604). If the navigation to the comment succeeds and the user interacts with the file, then the file may be opened and the navigation will end (step 605). The first view that opens may then show the comment. If comment is no longer there, feedback is provided to the user. If the cache file is fresher than the notification, the application may navigate into the cached copy and determine whether the referred content is in the cache file (step 606). If the navigation fails, the user may be shown a message saying, “comment has been moved or deleted” (step 607). If there are no pending changes, there may not be a “refresh needed” biz-bar when the user clicks on a notification and file opens to the content/comment (step 608).

FIG. 7 illustrates computing system 701, which is representative of any system or visual representation of systems in which the various applications, services, scenarios, and processes disclosed herein may be implemented. Examples of computing system 701 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709. Processing system 702 is operatively coupled with storage system 703, communication interface system 707, and user interface system 709.

Processing system 702 loads and executes software 705 from storage system 703. Software 705 includes process 706, which is representative of the processes discussed with respect to the preceding FIGS. 1-6, including indication process 200. When executed by processing system 702 to enhance an application, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device, but may also be distributed across multiple processing devices or sub-systems that cooperate in executing program instructions. Examples of processing system 702 include general purpose central processing units, graphical processing unites, application specific processors, and logic devices, as well as any other type of processing device, combination, or variation.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. Storage system 703 may be implemented as a single storage device, but may also be implemented across multiple storage devices or sub-systems co-located or distributed relative to each other. Storage system 703 may comprise additional elements, such as a controller, capable of communicating with processing system 702 or possibly other systems.

Software 705 may be implemented in program instructions and among other functions may, when executed by processing system 702, direct processing system 702 to operate as described with respect to the various operational scenarios, sequences, and processes illustrated herein. Software 705 may include program instructions for implementing indication process 200.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtual machine software, or other application software, in addition to or that include process 706. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system to enhance canvas service for graphically organizing content in a user interface. Indeed, encoding software 705 on storage system 703 may transform the physical structure of storage system 703. The specific transformation of the physical structure may depend on various factors in different implementations of this description. Such factors may include, but are not limited to, the technology used to implement the storage media of storage system 703 and whether the computer-storage media are characterized as primary or secondary storage, as well as other factors.

If the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 709 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 709. In some cases, the input and output devices may be combined in a single device, such as a display capable of displaying images and receiving touch gestures. The aforementioned user input and output devices are well known in the art and need not be discussed at length here. User interface system 709 may also include associated user interface software executable by processing system 702 in support of the various user input and output devices discussed above.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here.

In any of the aforementioned examples in which data, content, or any other type of information is exchanged, the exchange of information may occur in accordance with any of a variety of protocols, including FTP (file transfer protocol), HTTP (hypertext transfer protocol), HTTPS, REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Certain inventive aspects may be appreciated from the foregoing disclosure, of which the following are various examples.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. Those skilled in the art will understand and appreciate that a method could alternatively be represented as a series of interrelated states or events, such as in a state diagram. Moreover, not all acts illustrated in a methodology may be required for a novel implementation.

### Example 1

A computer apparatus comprising: one or more computer readable storage media; one or more processors operatively coupled to the one or more computer readable storage media; and program instructions stored on the one or more computer readable storage media that, when executed by the one or more processors, direct the one or more processors to at least: display a cached version of a collaborative document in a user interface to an application; query a source of the collaborative document external to the cached version of the collaborative document for changes that have occurred to content within the collaborative document since the cached version of the collaborative document was generated; and if a change has occurred to the content within the collaborative document, display an indication in the user interface that the cached version of the collaborative document is being updated based on the change.

### Example 2

The computer apparatus of Example 1 wherein: the user receives a notification indicating that the change occurred to the content within the collaborative document; and the cached version of the collaborative document is displayed in response to a user request to view the change indicated in the notification.

### Example 3

The computer apparatus of Examples 1-2 wherein the notification indicating that the change has occurred to the content in the collaborative document is generated based on a mention or comment that is associated with the user.

### Example 4

The computer apparatus of Examples 1-3 wherein to display the cached version of the collaborative document in the user interface, the one or more processors are directed to: determine a location within the cached version of the collaborative document associated with the change using deep-linking; and display the determined location within the cached version of the collaborative document in the user interface.

### Example 5

The computer apparatus of Examples 1-4 wherein to query the source of the collaborative document external to the cached version of the collaborative document for the changes, the one or more processors are directed to query the source of the collaborative document for changes that have been made by other users associated with the collaborative document.

### Example 6

The computer apparatus of Examples 1-5 wherein to query the source of the collaborative document external to the cached version of the collaborative document for the changes, the one or more processors are directed to query the source of the collaborative document for changes that have been made by the user to the collaborative document using another device.

### Example 7

The computer apparatus of Examples 1-6 wherein the indication that the cached version of the collaborative document is being updated based on the change comprises a progress loading watermark indicating an amount of changes that have been merged into the cached version of the collaborative document from a total amount of changes that have occurred to content within the collaborative document since the cached version of the collaborative document was generated.

### Example 8

The computer apparatus of Examples 1-7 wherein the one or more processors are further directed to display one or more updated versions of the collaborative document in response to one or more changes being merged into the cached version of the collaborative document.

### Example 9

The computer apparatus of Examples 1-8 wherein the one or more processors are further directed to display a summary of changes in the user interface in response to the changes being merged into the cached version of the collaborative document.

### Example 10

A method comprising: displaying a cached version of a collaborative document in a user interface to an application; querying a source of the collaborative document external to the cached version of the collaborative document for changes that have occurred to content within the collaborative document since the cached version of the collaborative document was generated; and if a change has occurred to the content within the collaborative document, displaying an indication in the user interface that the cached version of the collaborative document is being updated based on the change.

### Example 11

The method of Example 10 wherein: the user receives a notification indicating that the change occurred to the content within the collaborative document; and the cached version of the collaborative document is displayed in response to a user request to view the change indicated in the notification.

### Example 12

The method of Examples 10-11 wherein the notification indicating that the change has occurred to the content in the collaborative document is generated based on a mention or comment that is associated with the user.

### Example 13

The method of Examples 10-12 wherein displaying the cached version of the collaborative document in the user interface comprises determining a location within the cached version of the collaborative document associated with the change using deep-linking and displaying the determined location within the cached version of the collaborative document in the user interface.

### Example 14

The method of Examples 10-13 wherein querying the source of the collaborative document external to the cached version of the collaborative document for the changes comprises querying the source of the collaborative document for changes that have been made by other users associated with the collaborative document.

### Example 15

The method of Examples 10-14 wherein querying the source of the collaborative document external to the cached version of the collaborative document for the changes comprises querying the source of the collaborative document for changes that have been made by the user to the collaborative document using a different device.

### Example 16

The method of Examples 10-15 wherein the indication that the cached version of the collaborative document is being updated based on the change comprises a progress loading watermark indicating an amount of changes that have been merged into the cached version of the collaborative document from a total amount of changes that have occurred to content within the collaborative document since the cached version of the collaborative document was generated.

### Example 17

The method of Examples 10-16 further comprising displaying one or more updated versions of the collaborative document in response to one or more changes being merged into the cached version of the collaborative document.

### Example 18

The method of Examples 10-17 further comprising displaying a summary of changes in the user interface in response to the changes being merged into the cached version of the collaborative document.

### Example 19

One or more computer readable storage media having program instructions stored thereon, wherein the program instructions, when executed by one or more processors, direct the one or more processors to at least: transfer a notification indicating that a change occurred to content within a collaborative document; in response to a user request to view the change indicated in the notification, display a cached version of the collaborative document in a user interface; identify changes that have occurred to the content within the collaborative document since the cached version of the collaborative document was generated; and if a change has occurred to the content within the collaborative document, display an indication in the user interface that the cached version of the collaborative document is being updated based on the change.

### Example 20

The one or more computer readable storage media of Example 19 wherein the notification indicating that the change has occurred to the content in the collaborative document is generated based on a mention or comment that is associated with the user.

1. A computer apparatus comprising:
one or more computer readable storage media;
one or more processors operatively coupled to the one or more computer readable storage media; and
program instructions stored on the one or more computer readable storage media that, when executed by the one or more processors, direct the one or more processors to at least:
display a cached version of a collaborative document in a user interface to an application;
query a source of the collaborative document external to the cached version of the collaborative document for changes that have occurred to content within the collaborative document since the cached version of the collaborative document was generated; and
if a change has occurred to the content within the collaborative document, display an indication in the user interface that the cached version of the collaborative document is being updated based on the change.

2. The computer apparatus of claim 1 wherein:
the user receives a notification indicating that the change occurred to the content within the collaborative document; and
the cached version of the collaborative document is displayed in response to a user request to view the change indicated in the notification.

3. The computer apparatus of claim 2 wherein the notification indicating that the change has occurred to the content in the collaborative document is generated based on a mention or comment that is associated with the user.

4. The computer apparatus of claim 1 wherein to display the cached version of the collaborative document in the user interface, the one or more processors are directed to:
determine a location within the cached version of the collaborative document associated with the change using deep-linking; and
display the determined location within the cached version of the collaborative document in the user interface.

5. The computer apparatus of claim 1 wherein to query the source of the collaborative document external to the cached version of the collaborative document for the changes, the one or more processors are directed to query the source of the collaborative document for changes that have been made by other users associated with the collaborative document.

6. The computer apparatus of claim 1 wherein to query the source of the collaborative document external to the cached version of the collaborative document for the changes, the one or more processors are directed to query the source of the collaborative document for changes that have been made by the user to the collaborative document using another device.

7. The computer apparatus of claim 1 wherein the indication that the cached version of the collaborative document is being updated based on the change comprises a progress loading watermark indicating an amount of changes that have been merged into the cached version of the collaborative document from a total amount of changes that have occurred to content within the collaborative document since the cached version of the collaborative document was generated.

8. The computer apparatus of claim 1 wherein the one or more processors are further directed to display one or more updated versions of the collaborative document in response to one or more changes being merged into the cached version of the collaborative document.

9. The computer apparatus of claim 1 wherein the one or more processors are further directed to display a summary of changes in the user interface in response to the changes being merged into the cached version of the collaborative document.

10. A method comprising:
displaying a cached version of a collaborative document in a user interface to an application;
querying a source of the collaborative document external to the cached version of the collaborative document for changes that have occurred to content within the collaborative document since the cached version of the collaborative document was generated; and
if a change has occurred to the content within the collaborative document, displaying an indication in the user interface that the cached version of the collaborative document is being updated based on the change.

11. The method of claim 10 wherein:
the user receives a notification indicating that the change occurred to the content within the collaborative document; and
the cached version of the collaborative document is displayed in response to a user request to view the change indicated in the notification.

12. The method of claim 11 wherein the notification indicating that the change has occurred to the content in the collaborative document is generated based on a mention or comment that is associated with the user.

13. The method of claim 10 wherein displaying the cached version of the collaborative document in the user interface comprises determining a location within the cached version of the collaborative document associated with the change using deep-linking and displaying the determined location within the cached version of the collaborative document in the user interface.

14. The method of claim 10 wherein querying the source of the collaborative document external to the cached version of the collaborative document for the changes comprises querying the source of the collaborative document for changes that have been made by other users associated with the collaborative document.

15. The method of claim 10 wherein querying the source of the collaborative document external to the cached version of the collaborative document for the changes comprises querying the source of the collaborative document for changes that have been made by the user to the collaborative document using a different device.

16. The method of claim 10 wherein the indication that the cached version of the collaborative document is being updated based on the change comprises a progress loading watermark indicating an amount of changes that have been merged into the cached version of the collaborative document from a total amount of changes that have occurred to content within the collaborative document since the cached version of the collaborative document was generated.

17. The method of claim 10 further comprising displaying one or more updated versions of the collaborative document in response to one or more changes being merged into the cached version of the collaborative document.

18. The method of claim 10 further comprising displaying a summary of changes in the user interface in response to the changes being merged into the cached version of the collaborative document.

19. One or more computer readable storage media having program instructions stored thereon, wherein the program instructions, when executed by one or more processors, direct the one or more processors to at least:
transfer a notification indicating that a change occurred to content within a collaborative document;
in response to a user request to view the change indicated in the notification, display a cached version of the collaborative document in a user interface;
identify changes that have occurred to the content within the collaborative document since the cached version of the collaborative document was generated; and
if a change has occurred to the content within the collaborative document, display an indication in the user interface that the cached version of the collaborative document is being updated based on the change.

20. The one or more computer readable storage media of claim 19 wherein the notification indicating that the change has occurred to the content in the collaborative document is generated based on a mention or comment that is associated with the user.
